(19) United States
(12) Patent Application Publication
(10) Pub. No.: US 2015/0084890 A1
(43) Pub. Date: Mar. 26, 2015

(54) INPUT DEVICE

(71) Applicant: Alps Electric Co., Ltd., Tokyo (JP)

(72) Inventor: Shinji Ishikawa, Miyagi-Ken (JP)

(73) Assignee: Alps Electric Co., Ltd.

(21) Appl. No.: 14/481,279

(22) Filed: Sep. 9, 2014

(30) Foreign Application Priority Data
Sep. 26, 2013 (JP) 2013-199770
Mar. 17, 2014 (JP) 2014-053534

(51) Int. Cl. G06F 3/041

(52) U.S. Cl. CPC G06F 3/041
USPC 345/173

(57) ABSTRACT

An input device includes: an operation unit on which an input operation is performed by the contact or approach of an operating body with or to an upper surface thereof, and which is supported so as to be movable downward; an input detection unit that detects the input operation; a pressing detection unit detecting that the operation unit has been moved downward; a drive member that drives the operation unit in a vertical direction; and a case member that holds the drive member. The drive member is disposed at a central position of the operation unit in plan view, the drive member is a solenoid actuator including a plunger, an upper end portion of the plunger is disposed so as to come into contact with a lower surface of the operation unit, and the plunger is pressed down by the operation unit with a downward movement of the operation unit.

### CLAIM OF PRIORITY

This application claims benefit of priority to Japanese Patent Application No. 2013-199770, filed on Sep. 26, 2013, and Japanese Patent Application No. 2014-053534, filed on Mar. 17, 2014, which are hereby incorporated by reference in their entirety.

### BACKGROUND

1. Field of the Disclosure

The present disclosure relates to an input device, and more particularly, to an input device that has a simple structure.

2. Description of the Related Art

Recently, the number of input devices of which input operations can be performed by the contact with an operation surface and which provide an operation feeling to an operator by applying vibration or the like has been increased. An input device disclosed in the following Japanese Patent No. 5173044 is known as this input device.

The input device disclosed in Japanese Patent No. 5173044 will be described below with reference to FIG. 17. FIG. 17 is an exploded perspective view showing the structure of the input device 900 disclosed in Japanese Patent No. 5173044.

As shown in FIG. 17, the input device 900 disclosed in Japanese Patent No. 5173044 includes a touch panel 902 as a detector that detects an operation tracing an operation surface, a pressing mechanism 903 that allows an operation for pressing the touch panel 902 down from a reference position, a push switch 905 as a pressing detector that detects a pressing operation performed by the pressing mechanism 903, and a drive mechanism 907 that allows the touch panel 902 to be driven upward from the reference position. The pressing mechanism 903 mainly includes a push rod 930 as a rod that comes into contact with the lower surface of the touch panel 902 on the basis of the pressing operation, a body 904 as a support that supports the push rod 930, and a spring 931 as a force generator that is provided in the body 904, generates a force in a direction of the touch panel 902, and applies the force to the push rod 930. The drive mechanism 907 mainly includes a gear shaft 970 and a motor 975. The input device 900 drives the touch panel 902 in a vertical direction by the drive of the drive mechanism 907. Since the touch panel 902 is driven in the vertical direction as described above, the input device 900 can provide an operation feeling to an operator. Further, when the touch panel 902 is pressed, the push switch 905 disposed below the touch panel 902 is operated and detects a pressing operation.

Since the drive mechanism 907 and the pressing mechanism 903 are formed separately from each other and each of the drive mechanism 907 and the pressing mechanism 903 includes a plurality of components, the structure of the input device 900 disclosed in Japanese Patent No. 5173044 is complicated.

### SUMMARY

An input device includes: an operation unit on which an input operation is capable of being performed by the contact between an operating body and an upper surface of the operation unit or the approach of the operating body to the upper surface of the operation unit, and which is supported so as to be capable of moving downward from a reference position according to pressing performed by the operating body and is formed in the shape of a flat plate; an input detection unit configured to detect the input operation performed on the operation unit; a pressing detection unit configured to detect that the operation unit has been moved downward from the reference position; a drive member that is provided below the operation unit and drives the operation unit in a vertical direction; and a case member configured to hold the drive member. The drive member is disposed at a central position of the operation unit in plan view, the drive member is a solenoid actuator including a columnar plunger that is capable of being driven in the vertical direction, an upper end portion of the plunger is disposed so as to come into contact with a lower surface of the operation unit, and the plunger is pressed down by the operation unit with a downward movement of the operation unit.

### BRIEF DESCRIPTION OF THE DRAWINGS

FIG. 1 is an exploded perspective view showing the structure of an input device according to a first embodiment;

FIG. 2 is a perspective view showing the appearance of the input device according to the first embodiment;

FIG. 3 is a perspective view showing the appearance of a pressing detection unit of the first embodiment;

FIGS. 4A to 4C are views showing an operation unit of the first embodiment;

FIGS. 5A and 5B are views showing a drive member of the first embodiment;

FIG. 6 is a perspective view showing the appearance of a regulating member of the first embodiment;

FIGS. 7A and 7B are views showing an interlocking member of the first embodiment;

FIGS. 8A and 8B are views showing a case member of the first embodiment;

FIG. 9 is a plan view showing a state in which rotation stopping members of the first embodiment are engaged with rotation stopping guide portions of the operation unit;

FIGS. 10A and 10B are views showing the disposition of the operation unit, a substrate, an input detection unit, and the pressing detection unit of the first embodiment;

FIG. 11 is a schematic cross-sectional view showing the structure of the input device according to the first embodiment;

FIG. 12 is a schematic plan view showing a positional relationship between elastic members, first damper members, and second damper members of the first embodiment in plan view;

FIG. 13 is a schematic view showing a positional relationship between a pressing portion, the pressing detection unit, and a plunger of the first embodiment;

FIG. 14 is a schematic view showing the operation of the operation unit when the operation unit of the first embodiment is pressed;

FIG. 15 is a schematic view showing a positional relationship between the pressing portion, the pressing detection unit and the plunger when the pressing portion of the first embodiment is pressed;

FIG. 16 is a schematic view showing the operation of the operation unit when the operation unit of the first embodiment is driven upward by the drive member; and

FIG. 17 is an exploded perspective view showing the structure of an input device disclosed in Japanese Patent No. 5173044.

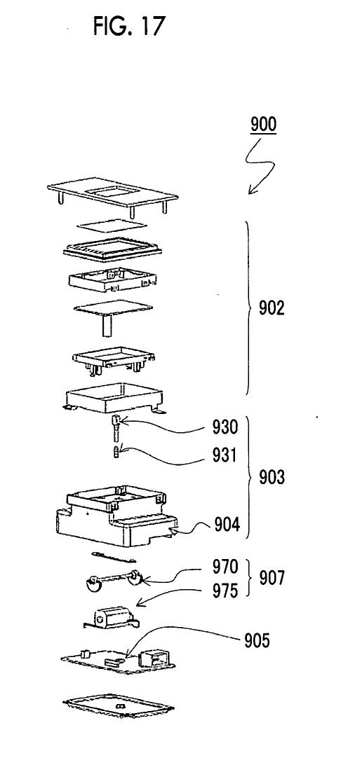

### DESCRIPTION OF THE EXEMPLARY EMBODIMENTS

An input device 100 according to a first embodiment will be described below.

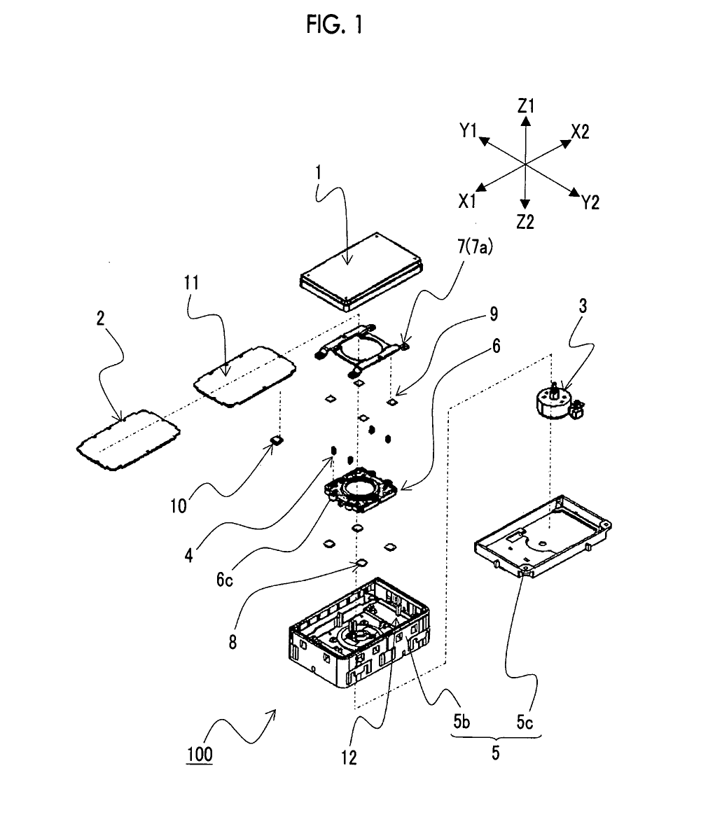

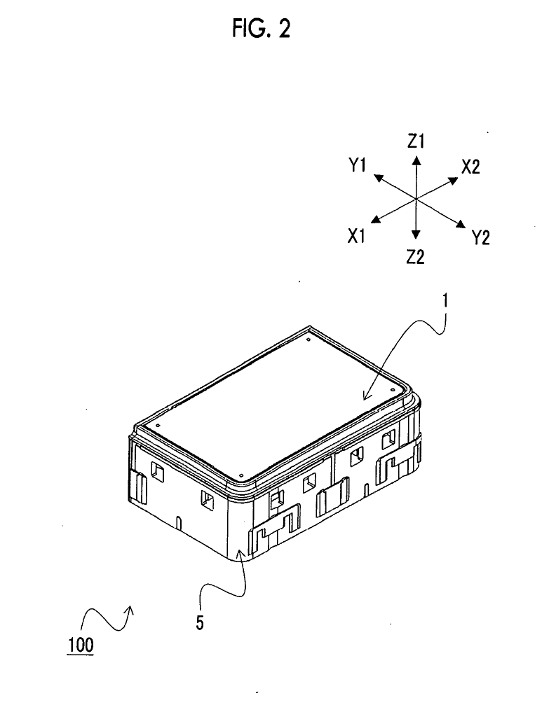

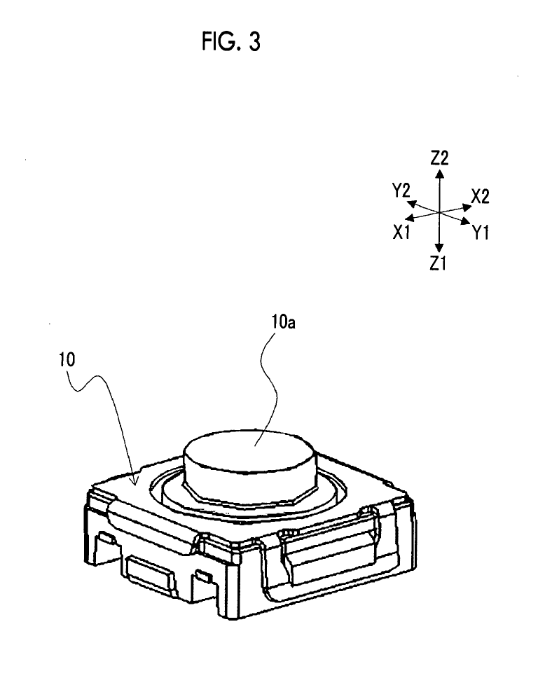

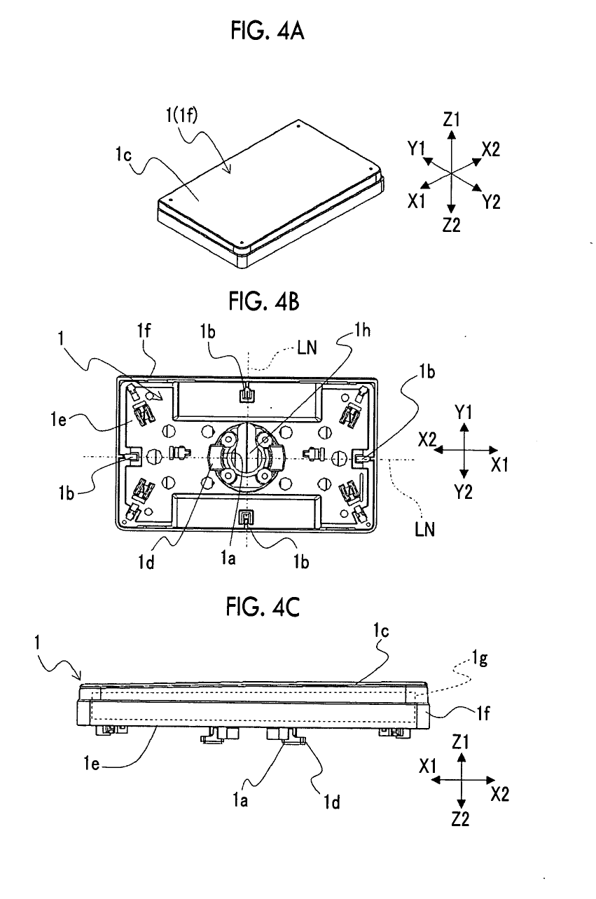

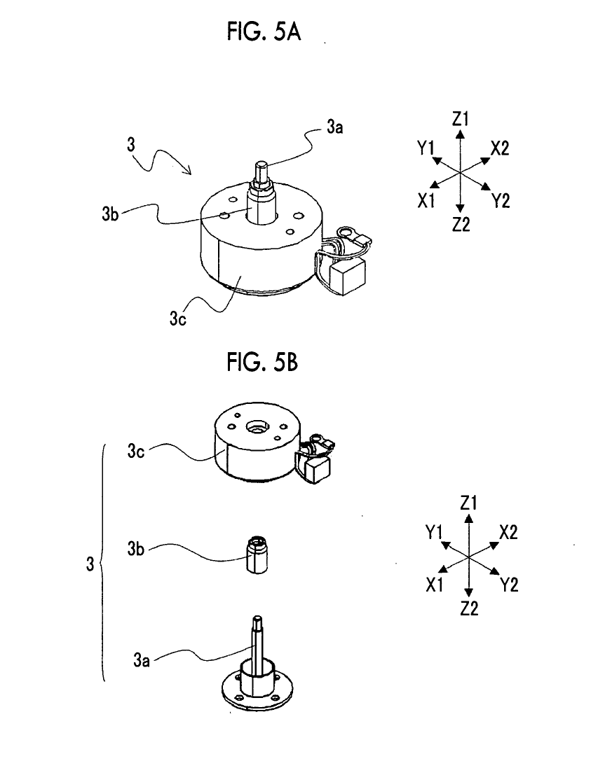

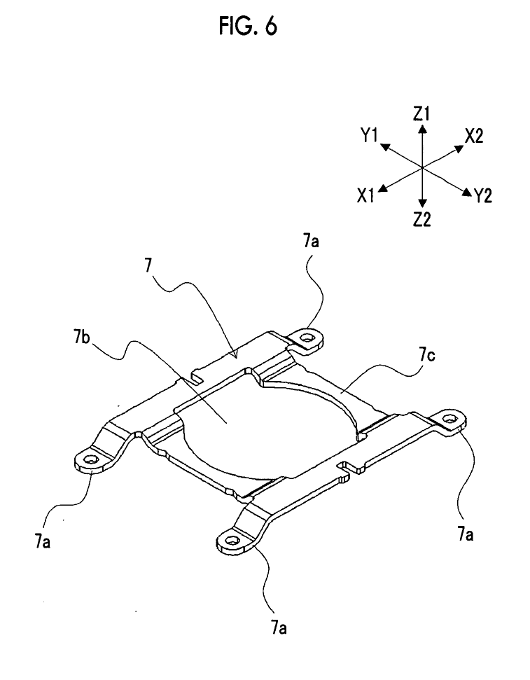

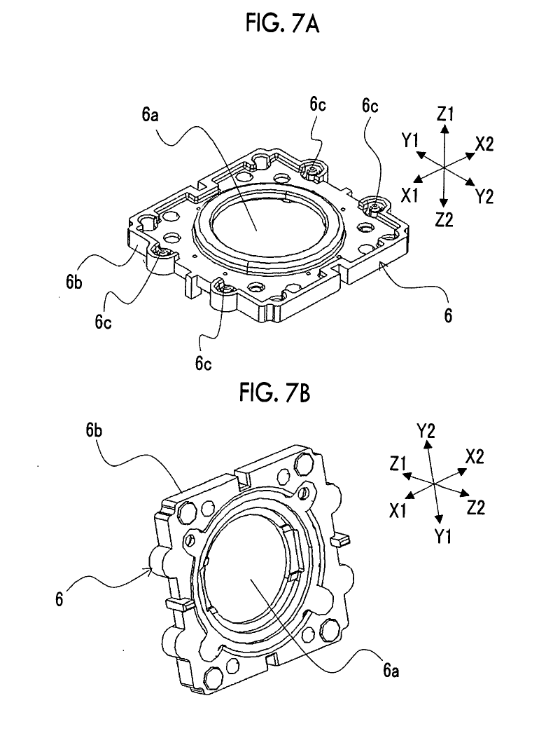

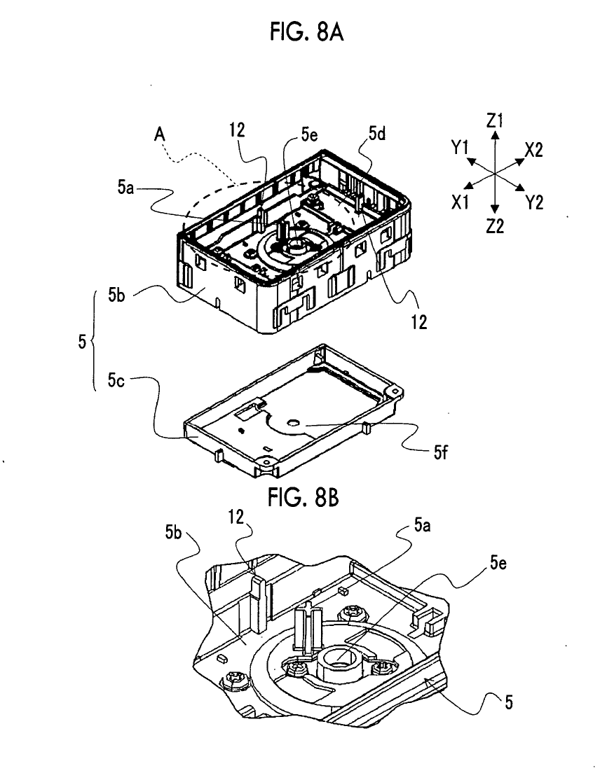

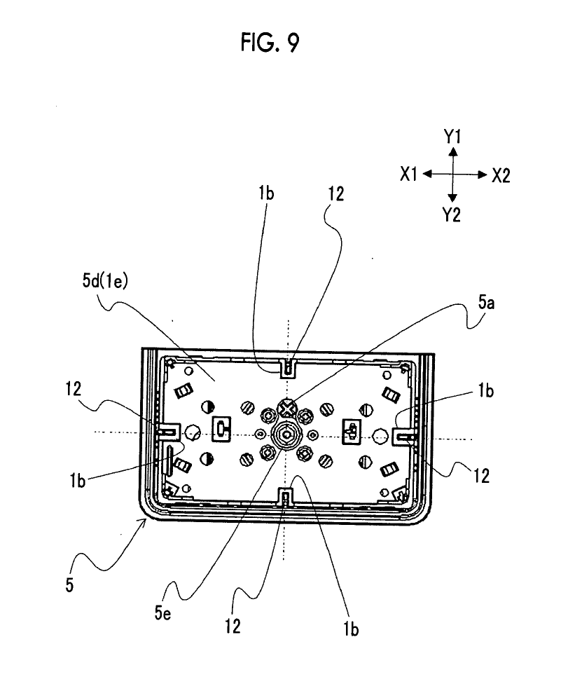

The structure of the input device 100 according to the first embodiment will be described first with reference to FIGS. 1 to 9. FIG. 1 is an exploded perspective view showing the structure of the input device 100 according to the first embodiment. FIG. 2 is a perspective view showing the appearance of the input device 100 according to the first embodiment. FIG. 3 is a perspective view showing the appearance of a pressing detection unit 10 of the first embodiment. FIGS. 4A to 4C are views showing an operation unit 1 of the first embodiment, FIG. 4A is a perspective view showing the appearance of the operation unit 1, FIG. 4B is a plan view showing the operation unit 1 that is viewed from the side corresponding to a Z2 direction shown in FIG. 4A, and FIG. 4C is a side view showing the operation unit 1 that is viewed from the side corresponding to a Y2 direction shown in FIG. 4A. FIGS. 5A and 5B are views showing a drive member 3 of the first embodiment, FIG. 5A is a perspective view showing the appearance of the drive member 3, and FIG. 5B is an exploded perspective view showing the structure of the drive member 3. FIG. 6 is a perspective view showing the appearance of a regulating member 7 of the first embodiment. FIGS. 7A and 7B are views showing an interlocking member 6 of the first embodiment, FIG. 7A is a perspective view showing the appearance of the interlocking member 6, and FIG. 7B is a perspective view showing the interlocking member 6 that is viewed from the side corresponding to the Z2 direction shown in FIG. 7A. FIGS. 8A and 8B are views showing a case member 5 of the first embodiment, FIG. 8A is an exploded perspective view showing the structure of the case member 5, and FIG. 8B is an enlarged view of a portion A shown in FIG. 8A. FIG. 9 is a plan view showing a state in which rotation stopping members 12 of the first embodiment are engaged with rotation stopping guide portions 1b of the operation unit 1.

As shown in FIG. 1, the input device 100 includes an operation unit 1, an input detection unit 2, a drive member 3, elastic members 4, a case member 5, an interlocking member 6, a regulating member 7, first damper members 8, second damper members 9, a pressing detection unit 10, a substrate 11, and rotation stopping members 12. As shown in FIG. 2, the input device 100 is formed in a substantially rectangular parallelepiped shape, and the operation unit 1 is provided on the upper surface (the surface corresponding to a Z1 direction) of the input device 100. Accordingly, input can be performed when an operating body OB (for example, a finger of a human) comes into contact with the operation unit 1 or presses the operation unit 1.

The first damper member 8 has elasticity, and is formed of a rubber sheet formed in a rectangular shape as shown in FIG. 1. Meanwhile, four first damper members 8 are used in this embodiment.

The second damper member 9 has elasticity, and is formed of a rubber sheet formed in a rectangular shape as shown in FIG. 1. Meanwhile, four second damper members 9 are used in this embodiment.

The elastic member 4 is formed of a metal wire rod, and is formed in the shape of a coil spring as shown in FIG. 1. Meanwhile, four elastic members 4 are used in this embodiment.

The substrate 11 is formed of a rigid substrate such as a glass epoxy substrate, and is formed in the shape of a substantially rectangular flat plate as shown in FIG. 1. Circuits are formed on both surfaces of the substrate 11.

The input detection unit 2 is a unit that is referred to as a capacitive touch panel or touch pad, and is formed in the shape of a substantially rectangular flat plate that has substantially the same size as the size of the substrate 11 as shown in FIG. 1. The input detection unit 2 includes an input surface 2a that detects an input operation by a change in capacitance occurring when the operating body OB comes into contact with or approaches the upper surface (the surface corresponding to the Z1 direction) of the input detection unit 2. The input surface 2a is formed in the shape of a smooth flat surface.

The pressing detection unit 10 is formed of a push switch 10b including an operation button 10a that can be pressed as shown in FIG. 3, and the operation button 10a can be pressed in the Y2 direction. When the operation button 10a is pressed, the pressing detection unit 10 detects the pressing of the operation button 10a by the switching of the electrical connection of an electrical circuit that is formed in the pressing detection unit 10. Meanwhile, when the pressing of the operation button 10a is stopped, the operation button 10a returns to a position where the operation button 10a is not yet pressed and the electrical connection of the electrical circuit also returns to a state where the operation button 10a is not yet pressed.

The operation unit 1 is made of a synthetic resin material and is formed in the shape of a rectangular flat plate as shown in FIGS. 4A to 4C. Meanwhile, in this embodiment, the operation unit 1 includes a receiving tray part 1e that is formed in the shape of a flat plate and a lid part 1f that covers the receiving tray part 1e. When the lid part 1f is disposed so as to be superimposed on the receiving tray part 1e, a space 1g in which the substrate 11 on which the pressing detection unit 10 and the like have been mounted and the input detection unit 2 can be received is formed in the operation unit 1. The upper surface of the operation unit 1 is formed of a smooth flat surface, and an operation surface 1c, which receives an operation performed by the operating body OB, is formed on the upper surface of the operation unit 1. Further, the operation unit 1 includes a connection portion 1a that is formed so as to extend downward from the center of the lower surface of the operation unit 1. The connection portion 1a is formed in a cylindrical shape, but portions of the cylindrical surface of the connection portion 1a corresponding to a Y1-Y2 direction are notched. Accordingly, the connection portion 1a is divided into a portion corresponding to an X1 direction and a portion corresponding to an X2 direction. The operation unit 1 includes a plate-like hook portion 1d that is formed at an end of the portion of the connection portion 1a corresponding to the X1 direction so as to protrude in the X1 direction and a plate-like hook portion 1d that is formed at an end of the portion of the connection portion 1a corresponding to the X2 direction so as to protrude in the X2 direction. Furthermore, the operation unit 1 includes a center hole 1h that is formed at the center of the lower surface thereof so as to communicate with the space 1g. The center hole 1h is formed so as to extend in the Y1 direction from a cylindrical inner portion of the connection portion 1a and the notch of the cylindrical surface corresponding to the Y1 direction. Moreover, the operation unit 1 includes rotation stopping guide portions 1b that are formed on side surfaces in the shape of a notch. The rotation stopping guide portions 1b are formed at positions where a straight line LN, which passes through the center of the operation unit 1 and substantially bisects the operation unit 1, intersects with the side surfaces in plan view. Meanwhile, since the rotation stopping guide portions 1b are formed on the side surfaces of the receiving tray part 1e and are covered with the lid part 1f in this embodiment, only notches of the lower surface are exposed to the outside.

As shown in FIGS. 5A and 5B, the drive member 3 is a solenoid actuator 3c including a columnar plunger 3a that can be driven in a vertical direction (Z1-Z2 direction), and the solenoid actuator 3c includes a guide member 3b that is disposed at an upper portion thereof so as to surround the periphery of the plunger 3a. The solenoid actuator 3c (the drive member 3) can drive the plunger 3a in the vertical direction by an electromagnetic force that is generated by the flow of current.

The regulating member 7 is formed of a metal plate, and is formed in the shape of a rectangular flat plate in plan view as shown in FIG. 6. The regulating member 7 includes a body portion 7c that is formed in the shape of a rectangular flat plate, and includes a first opening 7b that is formed at the center of the body portion 7c and has a circular shape. Further, the regulating member 7 includes a plurality of legs 7a extending downward, and the legs 7a extend from four corners of the body portion 7c downward and in the X1-X2 direction in this embodiment.

The interlocking member 6 is made of a synthetic resin material, and is formed in the shape of a flat plate as shown in FIGS. 7A and 7B. The interlocking member 6 includes a base portion 6b that is formed in the shape of a flat plate, and includes a second opening 6a that is formed at the center of the base portion 6b and has a diameter smaller than the diameter of the first opening 7b. Further, the diameter of the second opening 6a is larger than the diameter of the connection portion 1a of the operation unit 1, and is smaller than a distance between the ends of the hook portions 1d. Furthermore, the interlocking member 6 includes elastic member disposition portions 6c that are formed at outer peripheral ends of the base portion 6b facing each other with the second opening 6a interposed therebetween, that is, at both outer peripheral ends of the base portion 6b corresponding to the X1-X2 direction. The elastic member disposition portions 6c are formed in a recessed shape so that the elastic members 4 can be disposed in the elastic member disposition portions 6c. Two elastic member disposition portions 6c are provided on each of the side corresponding to the X1 direction and the side corresponding to the X2 direction.

The case member 5 is made of a synthetic resin material, and is formed in a rectangular parallelepiped shape as shown in FIG. 2. As shown in FIGS. 8A and 8B, the case member 5 includes an upper case member 5b and a lower case member 5c, and is formed when the upper case member 5b is disposed so as to be superimposed on the lower case member 5c. The upper case member 5b includes a receiving portion 5d that is formed on the upper surface thereof in the shape of a recess having a rectangular shape in plan view. A through hole 5e, which passes through the receiving portion 5d in the vertical direction, is formed at the central portion of the receiving portion 5d. Meanwhile, the through hole 5e is formed so as to have the size where the plunger 3a and the guide member 3b of the drive member 3 can be inserted. Further, the case member 5 includes a pressing portion 5a that is formed so as to extend upward, and the pressing portion 5a is formed apart from the through hole 5e with a small interval therebetween in the Y1 direction. The lower case member 5c is formed in a hollow shape of which the upper side is opened, and a disposition portion 5f in which the drive member 3 can be disposed is formed in the lower case member 5c. Meanwhile, when the upper case member 5b is disposed so as to be superimposed on the lower case member 5c to form the case member 5, the disposition portion 5f is connected to the receiving portion 5d through the through hole 5e.

The rotation stopping member 12 is made of a synthetic resin material and is formed in the shape of a bar. Meanwhile, in this embodiment, the rotation stopping members 12 are formed integrally with the case member 5 as shown in FIGS. 8A, 8B and 9. The rotation stopping members 12 are formed in the receiving portion 5d of the case member 5 so as to protrude upward, are formed in a shape that can be engaged with the rotation stopping guide portions 1b, and are disposed at positions where the rotation stopping members 12 can be engaged with the rotation stopping guide portions 1b. Meanwhile, the rotation stopping members 12 are formed at positions where a straight line bisecting the receiving portion 5d, which is formed in a rectangular shape, in the X1-X2 direction, and a straight line bisecting the receiving portion 5d in the Y1-Y2 direction intersect with the sides of the receiving portion 5d in the plan view of the receiving portion 5d of the case member 5.

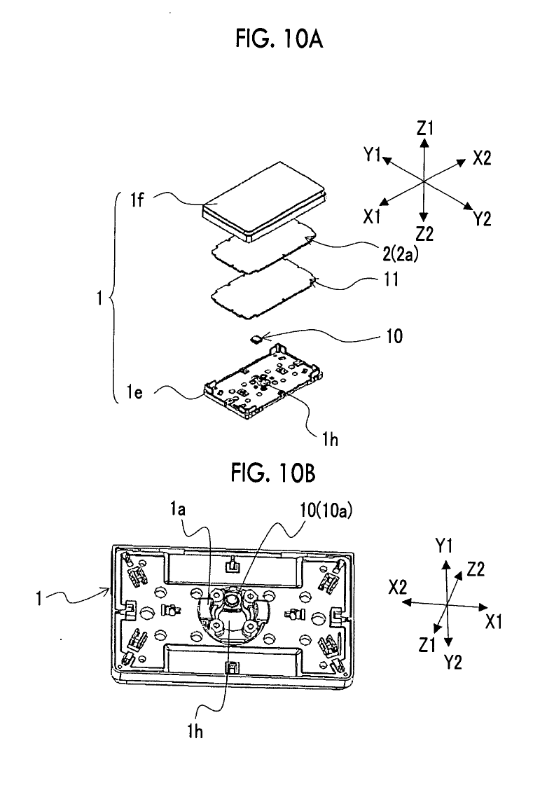

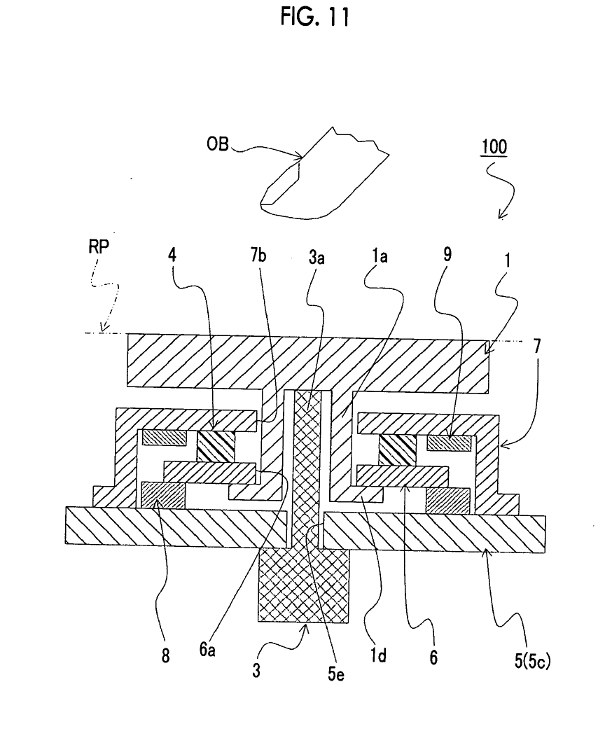

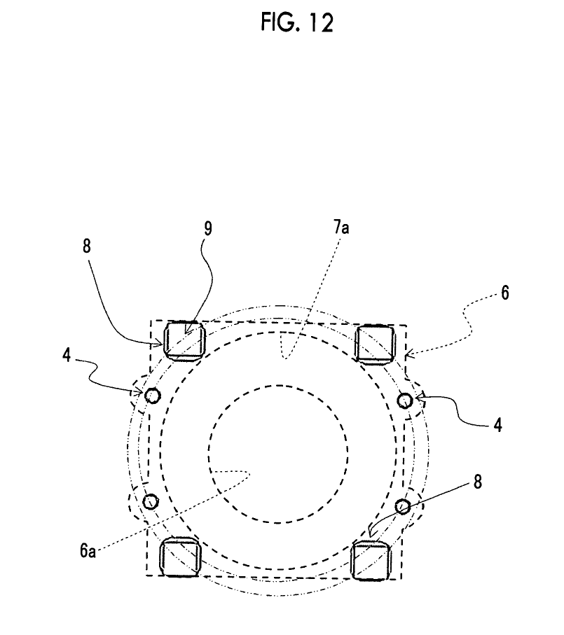

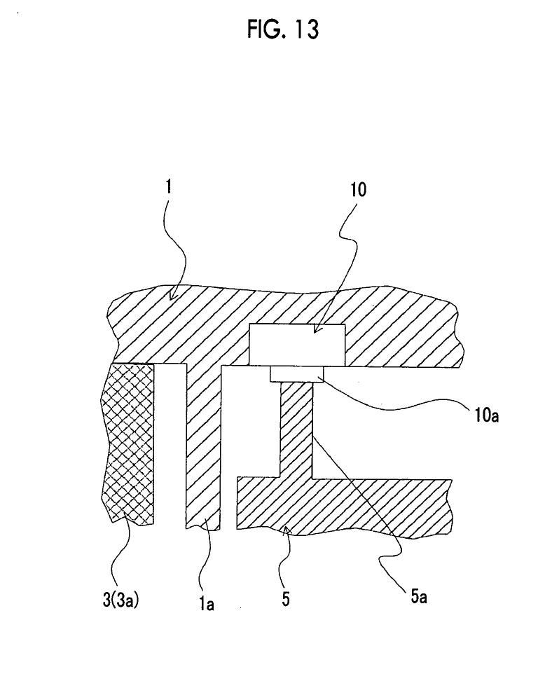

Next, the structure of the input device 100 will be described with reference to FIG. 1 and FIGS. 9 to 13. FIGS. 10A and 10B are views showing the disposition of the operation unit 1, the substrate 11, the input detection unit 2, and the pressing detection unit 10 of the first embodiment; FIG. 10A is an exploded perspective view showing the disposition of the operation unit 1, the substrate 11, the input detection unit 2, and the pressing detection unit 10; and FIG. 10B is a perspective view showing a state where the operation button 10a is exposed from the center hole 1h. FIG. 11 is a schematic cross-sectional view showing the structure of the input device 100 according to the first embodiment. Meanwhile, there also are portions different from an actual structure in FIG. 11. FIG. 12 is a schematic plan view showing a positional relationship between the elastic members 4, the first damper members 8, and the second damper members 9 of the first embodiment in plan view. FIG. 13 is a schematic view showing a positional relationship between the pressing portion 5a, the pressing detection unit 10, and the plunger 3a of the first embodiment.

As shown in FIG. 1, the elastic members 4 are disposed in the four elastic member disposition portions 6c that are formed at the interlocking member 6, respectively. Further, the plurality of second damper members 9 are provided along the circumference, which is concentric with the first opening 7b and has a large diameter, on the lower surface of the regulating member 7, and are locked near bases of the leg 7a in this embodiment, respectively.

Furthermore, as shown in FIG. 10A, the input detection unit 2 is superimposed on the upper surface of the substrate 11, and is disposed so that the input surface 2a does not face the substrate 11. Moreover, the pressing detection unit 10 is provided on the lower surface of the substrate 11 so that the operation button 10a faces the lower side. The input detection unit 2 and the substrate 11 on which the pressing detection unit 10 has been disposed are disposed on the lower surface of the operation unit 1 as described above. However, in this embodiment, the input detection unit 2 and the substrate 11 are disposed on the lower surface of the lid part 1f and the receiving tray part 1e is disposed on the lower surface of the substrate 11. That is, the input surface 2a of the input detection unit 2 is disposed in the space 1g of the operation unit 1 so as to face the lid part 1f. Meanwhile, since the operation button 10a of the pressing detection unit 10 is exposed to the lower side from the center hole 1h as shown in FIG. 10B, the operation button 10a can be operated from below.

Further, as shown in FIG. 11, the interlocking member 6 is provided below the operation unit 1 and the regulating member 7 is provided between the operation unit 1 and the interlocking member 6. The interlocking member 6, which is disposed as described above, is connected to the operation unit 1 that is inserted into the regulating member 7. That is, the connection portion 1a of the operation unit 1 is inserted into the first opening 7b of the regulating member 7 and is inserted into the second opening 6a of the interlocking member 6 and the hook portion 1d is engaged with the second opening 6a, so that the operation unit 1 and the interlocking member 6 are connected to each other. Meanwhile, the interlocking member 6 is connected so as to be movable along the connection portion 1a in the vertical direction. Since the operation unit 1, the interlocking member 6, and the regulating member 7 are disposed as described above, the elastic members 4 are provided below the operation unit 1 and the second damper members 9 are disposed on the surface of the regulating member 7 facing the interlocking member 6.

Furthermore, the drive member 3 is disposed in the disposition portion 5f (see FIG. 8A) of the lower case member 5c and the upper case member 5b (see FIG. 8A) is disposed so as to be superimposed on the lower case member 5c and is engaged with the lower case member 5c, so that the case member 5 holds the drive member 3. The plunger 3a of the drive member 3, which is held by the case member 5, protrudes from the through hole 5e. Accordingly, the plunger 3a is disposed close to the pressing portion 5a (see FIGS. 8A and 8B), and protrudes upward in parallel with the pressing portion 5a. Further, four first damper members 8 are disposed at regular intervals so as to surround the periphery of the through hole 5e.

Next, the operation unit 1, the interlocking member 6, and the regulating member 7, which are integrated with each other, are disposed in the receiving portion 5d of the case member 5 so that the operation unit 1 is exposed to the upper surface of the case member 5. The regulating member 7 is mounted on the case member 5 through the legs 7a so as to cover the interlocking member 6. Accordingly, the operation unit 1, the interlocking member 6, and the regulating member 7, which are integrated with each other, are locked to the case member 5, and the first damper members 8 are provided below the interlocking member 6 so as to be capable of coming into contact with the interlocking member 6. Meanwhile, since the regulating member 7 is locked to the case member 5, the elastic members 4 are interposed between the interlocking member 6 and the regulating member 7 and bias the interlocking member 6 to the lower side. Accordingly, the interlocking member 6 comes into contact with the first damper members 8. Further, since the elastic members 4 bias the interlocking member 6 to the lower side, the operation unit 1, which comes into contact with the interlocking member 6 by the hook portions 1d, are elastically biased so as to come into press contact with the plunger 3a. Accordingly, the operation unit 1 is supported so as to be capable of moving downward from a reference position RP according to the pressing that is performed by the operating body OB. Furthermore, the elastic members 4, the first damper members 8, and the second damper members 9, which are disposed as described above, are disposed at a plurality of positions, that is, at four positions in this embodiment that are concentric with the center of the flat plate-like interlocking member 6 and are present outside the first opening 7b in plan view as shown in FIG. 12. Moreover, as shown in FIG. 9, the rotation stopping guide portion 1b and the rotation stopping members 12 are slidably engaged with each other. Further, as shown in FIG. 11, the drive member 3 is provided below the operation unit 1 and is disposed at a central position of the operation unit 1 in plan view, and the plunger 3a is inserted into the second and first openings 6a and 7b and is disposed so that the upper end portion of the plunger 3a comes into contact with the lower surface of the operation unit 1. Furthermore, as shown in FIG. 13, the pressing portion 5a and the pressing detection unit 10 are disposed close to the plunger 3a and the pressing portion 5a is disposed so as to face the pressing detection unit 10 and is capable of pressing the operation button 10a. The input device 100 is formed in this way.

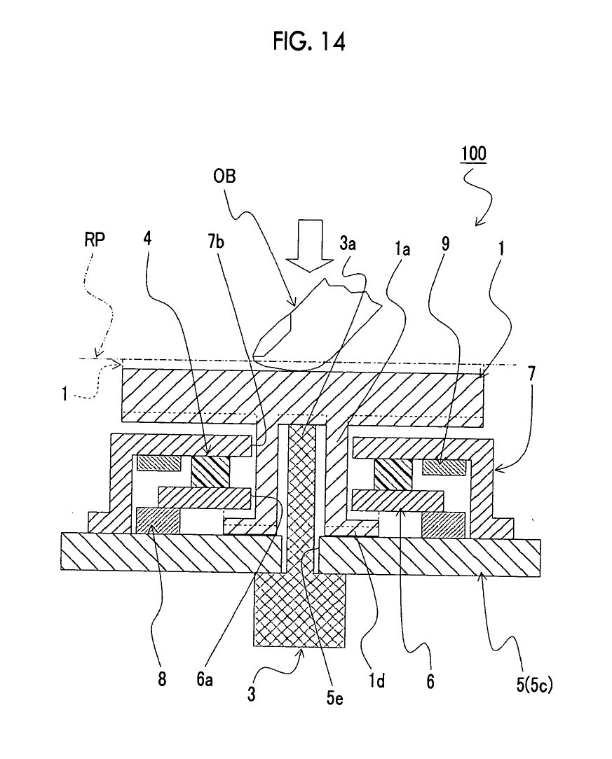

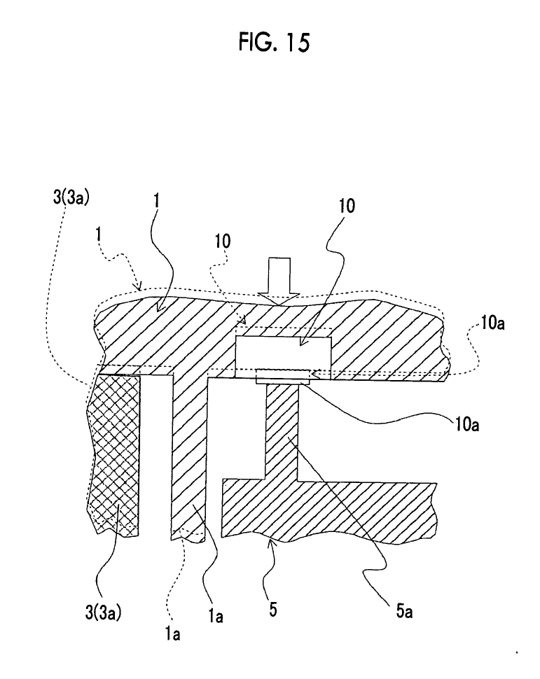

Next, the operation of the input device 100 will be described with reference to FIG. 11 and FIGS. 13 to 15. FIG. 14 is a schematic view showing the operation of the operation unit 1 when the operation unit 1 of the first embodiment is pressed. FIG. 15 is a schematic view showing a positional relationship between the pressing portion 5a, the pressing detection unit 10 and the plunger 3a when the pressing portion 5a of the first embodiment is pressed.

An input operation of the input device 100 can be performed by the contact between the operating body OB, such as a finger of a human, and the upper surface of the operation unit 1 or the approach of the operating body OB to the upper surface of the operation unit 1, and an input operation of the input device 100 can be performed by the pressing of the operation unit 1 that is performed by the operating body OB. The input operation, which is performed by the contact between the operating body OB and the upper surface of the operation unit 1 or the approach of the operating body OB to the upper surface of the operation unit 1, will be described first. The input surface 2a, which can detect a change in capacitance, of the input detection unit 2, which is a capacitive touch panel, of the input device 100 is disposed in the operation unit 1 (the space 1g) so as to face the upper side. Capacitance is changed when the operating body OB comes into contact with or approaches the upper surface of the operation unit 1. Accordingly, when the input surface 2a detects a change in capacitance, the input surface 2a determines that an input operation is performed. Therefore, the input surface 2a can detect an input operation that is performed on the operation unit 1.

Next, an operation, which is performed when an input operation is performed by the pressing of the operation unit 1, will be described. When the operation unit 1 is not pressed, the operation unit 1 is present at the height of the reference position RP as shown in FIG. 11 and the pressing detection unit 10 is in an unpressed state as shown in FIG. 13.

When the operation unit 1 is pressed down, the contact between the hook portions 1d and the interlocking member 6 is released and the operation unit 1 is moved downward from the reference position RP as shown in FIG. 14. Meanwhile, while being guided by the guide member 3b, the plunger 3a is pressed down by the operation unit 1 with the downward movement of the operation unit 1. That is, the guide of the operation unit 1 in the vertical direction is performed by the guide member 3b of the plunger 3a. Since the operation unit 1 is moved downward in this way, the operation button 10a of the pressing detection unit 10 disposed so as to face the pressing portion 5a, is pressed by the pressing portion 5a as shown in FIG. 15 and the electrical connection of the electrical circuit formed in the pressing detection unit 10, and thus is switched. Accordingly, the downward movement of the operation unit 1 from the reference position RP is detected. That is, the pressing detection unit 10 detects that the operation unit 1 is pressed. Further, when the pressing of the operation unit 1 is released, the operation unit 1 returns to a state shown in FIG. 11 where the operation unit 1 is not yet pressed.

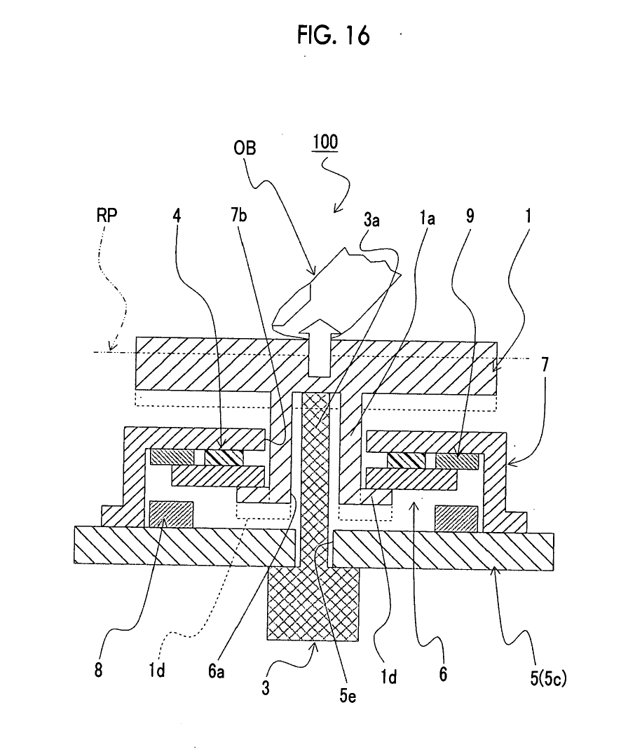

Next, an operation for giving an operation feeling to an operator will be described with reference to FIGS. 11 and 16. FIG. 16 is a schematic view showing the operation of the operation unit 1 when the operation unit 1 of the first embodiment is driven upward by the drive member 3. The input device 100 is set so that the drive member 3 applies vibration to the operation unit 1 to provide an operation feeling to the operator when the operation unit 1 is pressed. When the pressing detection unit 10 detects that the operation unit 1 has been pressed, a current flows in the drive member 3. When the current flows in the solenoid actuator 3c (the drive member 3), an electromagnetic force is generated and the plunger 3a is driven in the vertical direction while being guided by the guide member 3b. When the plunger 3a is driven in the vertical direction as described above, the drive member 3 drives the operation unit 1 in the vertical direction to apply vibration to the operation unit 1. Accordingly, the drive member 3 provides an operation feeling to an operator. When the plunger 3a is moved upward, the operation unit 1 is pushed upward and the interlocking member 6 is driven upward together with the operation unit 1 as shown in FIG. 16. At this time, the elastic members 4 are pressed against a biasing force and are compressed. The interlocking member 6, which has been driven upward together with the operation unit 1, collides with the second damper members 9. Since the upward movement of the interlocking member 6, which has collided with the second damper members 9, is regulated through the second damper members 9 by the regulating member 7, the upward movement of the interlocking member 6 is stopped. When the plunger 3a is moved down, the interlocking member 6 of which the upward movement has been stopped is flicked downward by the biasing force of the elastic members 4 that elastically bias the interlocking member 6 so as to make the interlocking member 6 come into press contact with the first damper members 8 and the biasing force of the second damper members 9 that are compressed by the collision of the interlocking member 6 as shown in FIG. 11. Accordingly, the interlocking member 6 is driven downward together with the operation unit 1. The interlocking member 6, which has been driven downward together with the operation unit 1, collides with the first damper members 8 and the downward movement of the interlocking member 6 is stopped. Further, the operation unit 1 comes into contact with the plunger 3a, so that the downward movement of the operation unit 1 is stopped. When the plunger 3a is repeatedly moved up and down in this way, the input device 100 provides vibration to an operator through the operation unit 1 as an operation feeling.

An effect, which is obtained from this embodiment, will be described below.

The input device 100 according to this embodiment includes: the operation unit 1 on which an input operation can be performed by the contact between the operating body OB and the upper surface of the operation unit 1 or the approach of the operating body OB to the upper surface of the operation unit 1, and which is supported so as to be capable of moving downward from the reference position RP according to the pressing performed by the operating body OB and is formed in the shape of a flat plate; the input detection unit 2 that detects an input operation performed on the operation unit 1; the pressing detection unit 10 that detects that the operation unit 1 has been moved downward from the reference position RP; the drive member 3 that is provided below the operation unit 1 and drives the operation unit 1 in the vertical direction; and the case member 5 that holds the drive member 3. The drive member 3 is disposed at the central position of the operation unit 1 in plan view, and the drive member 3 is the solenoid actuator 3c including the columnar plunger 3a that can be driven in the vertical direction. The upper end portion of the plunger 3a is disposed so as to come into contact with the lower surface of the operation unit 1, and the plunger 3a is pressed down by the operation unit 1 with the downward movement of the operation unit 1.

Accordingly, since the drive member 3 is only the solenoid actuator 3c including the plunger 3a, the drive member 3 has a structure that is simpler than the structure of the drive mechanism 907 disclosed in Japanese Patent No. 5173044. Further, when the operation unit 1 is pressed, the drive member 3 is moved downward together with the operation unit 1 and also functions as a guide. Accordingly, an effect capable of providing an input device having a simple structure is obtained.

Furthermore, when the operating body OB is a finger of an operator, a finger of a human is likely to feel vibration differently in a planar direction according to the direction of vibration. Since there is vibration in a direction where the joints of a finger can easily move and vibration in a direction where the joints of a finger cannot easily move as the vibration in the planar direction, the finger of a human is likely to feel vibration differently according to the direction of vibration. That is, the finger of a human feels like a deviation is present in the operation feeling. In contrast, the finger of a human is able to substantially feel vibration stably in the vertical direction. Accordingly, since vibration in the planar direction cannot be applied to a finger and vibration in the vertical direction can be applied to a finger when the solenoid actuator 3c is used, an effect capable of providing an input device of which an operation feeling is stable is obtained.

Moreover, the input device 100 according to this embodiment includes the elastic members 4 that are provided below the operation unit 1, and are formed that the elastic members 4 elastically bias the operation unit 1 so as to make the operation unit 1 come into press contact with the plunger 3a.

Accordingly, since the plunger 3a of the drive member 3 comes into contact with the central position of the operation unit 1 in plan view and the elastic members 4 elastically bias the operation unit 1 so as to make the operation unit 1 come into press contact with the plunger 3a, it is possible to suppress the inclination of the operation unit 1. Therefore, a sense of being caught, which is caused by the inclination of the operation unit 1, is hardly generated when the operation unit 1 is pressed. Further, since the central position of the operation unit 1 in plan view is vibrated by the drive member 3, vibration is uniformly transmitted to the entire operation unit 1. Accordingly, the deviation of an operation feeling, which is caused by the difference of an operating position, is reduced. Therefore, an effect capable of providing an input device of which an operation feeling is good is obtained.

Furthermore, the input device 100 of this embodiment is formed so that the solenoid actuator 3c includes the guide member 3b disposed at an upper portion thereof so as to surround the periphery of the plunger 3a.

Accordingly, since the periphery of the plunger 3a is surrounded by the guide member 3b, the hindrance of the operation of the plunger 3a, which is caused by the contact between the plunger 3a and other components, hardly occurs and vibration can be reliably transmitted to the operation unit 1. Therefore, an effect capable of providing an input device of which an operation feeling is better is obtained.

Further, the input device 100 according to this embodiment is formed so that the case member 5 includes the pressing portion 5a formed to extend upward, the input detection unit 2 is provided on the substrate 11 disposed on the lower surface of the operation unit 1, the pressing detection unit 10 is formed of the push switch 10b including the operation button 10a capable of being pressed and is provided on the substrate 11 so that the operation button 10a faces the lower side, the pressing portion 5a is disposed so as to face the pressing detection unit 10 and is capable of pressing the operation unit 1, and the pressing portion 5a and the pressing detection unit 10 are disposed close to the plunger 3a.

Accordingly, since the input detection unit 2 and the pressing detection unit 10 are disposed on the same substrate 11, it is possible to simplify the structure of the input device. Furthermore, the pressing portion 5a is formed at a part of the case member 5, the push switch 10b disposed on the lower surface of the input detection unit 2 is pressed with the pressing of the operation unit 1, and the operation button 10a is operated by the pressing portion 5a. Accordingly, it is possible to simplify the detection mechanism of the pressing detection unit 10. Moreover, since the pressing portion 5a and the pressing detection unit 10 are disposed close to the plunger 3a, a plurality of components is disposed at a central portion (close to the drive member 3). As a result, it is possible to reduce the size of the input device. Therefore, an effect capable of providing an input device, which has a small size and a simple structure, is obtained.

Since the pressing portion 5a and the pressing detection unit 10 are disposed close to the plunger 3a, the pressing detection unit 10 (push switch 10b) is pressed near the center of the operation unit 1. Accordingly, since a force for pressing the outer peripheral end of the operation unit 1 is easily transmitted to the pressing portion 5a and the pressing detection unit 10 even when the outer peripheral end of the operation unit 1 is pressed, the push switch 10b is reliably pressed. Therefore, an effect capable of more reliably detecting pressing is obtained.

Further, the input device 100 according to this embodiment includes the rotation stopping members 12 formed in the shape of a bar, and is formed so that the operation unit 1 includes the rotation stopping guide portions 1b that are formed on side surfaces in the shape of a notch, and the rotation stopping members 12 are engaged with the rotation stopping guide portions 1b.

Accordingly, since the rotation stopping members 12 and the rotation stopping guide portions 1b are provided and the rotation stopping members 12 are engaged with the rotation stopping guide portions 1b, an effect capable of regulating the rotation of the operation unit 1, which is caused by vibration applied to the operation unit 1, is obtained.

Furthermore, the input device 100 according to this embodiment is formed so that the rotation stopping guide portions 1b are formed at the positions where the straight line LN, which passes through the center of the operation unit 1 and substantially bisects the operation unit 1, intersects with the side surfaces in plan view.

Accordingly, an effect capable of more stably regulating the rotation of the operation unit 1 is obtained.

The input device according to the embodiment of the invention has been specifically described as described above. However, the invention is not limited to the above-mentioned embodiment, and may have various modifications without departing from the scope of the invention. For example, the invention may include the following modifications, and these modifications also belong to the scope of the invention.

### First Modification

The rotation stopping guide portions 1b have been formed in the shape of a notch in the first embodiment, but may be formed in the shape of an opening or a hole. Meanwhile, the shape of the rotation stopping member 12 needs to be changed according to the shape of the rotation stopping guide portion 1b.

### Second Modification

The input detection unit 2 is a capacitive touch panel in the first embodiment, but may be a resistive film touch panel.

### Third Modification

In the first embodiment, the regulating member 7 is mounted on the case member 5 through the legs 7a extending downward. Even though, for example, the legs 7a are formed to be flush with the body portion 7c without extending downward, protruding portions corresponding to the legs 7a are formed at the case member 5, and the regulating member 7 is mounted on the protruding portions, the same effects as the effects obtained from the structure of the first embodiment can be obtained.

### Fourth Modification

In the first embodiment, the pressing detection unit 10 has formed of the push switch 10b which includes the operation button 10a and in which the electrical connection of the electrical circuit formed therein is switched. However, the pressing detection unit 10 may be, for example, a push switch in which a magnetoresistive element or the like is built.

It should be understood by those skilled in the art that various modifications, combinations, sub-combinations and alterations may occur depending on design requirements and other factors insofar as they are within the scope of the appended claims of the equivalents thereof.

What is claimed is:

1. An input device comprising:
an operation unit on which an input operation is performed by the contact between an operating body and an upper surface of the operation unit or the approach of the operating body to the upper surface of the operation unit, and which is supported so as to move downward from a reference position according to pressing performed by the operating body and is formed in the shape of a flat plate;
an input detection unit configured to detect the input operation performed on the operation unit;
a pressing detection unit configured to detect that the operation unit has been moved downward from the reference position;
a drive member that is provided below the operation unit and drives the operation unit in a vertical direction; and
a case member configured to hold the drive member,
wherein the drive member is disposed at a central position of the operation unit in plan view,
the drive member is a solenoid actuator including a columnar plunger that is driven in the vertical direction,
an upper end portion of the plunger is disposed so as to come into contact with a lower surface of the operation unit, and
the plunger is pressed down by the operation unit with a downward movement of the operation unit.

2. The input device according to claim 1, further comprising:
elastic members that are provided below the operation unit,
wherein the elastic members elastically bias the operation unit so as to make the operation unit come into press contact with the plunger.

3. The input device according to claim 1,
wherein the solenoid actuator includes a guide member that is disposed at an upper portion thereof so as to surround a periphery of the plunger.

4. The input device according to claim 1,
wherein the case member includes a pressing portion that is formed so as to extend upward,
the input detection unit is provided on a substrate that is disposed on the lower surface of the operation unit,
the pressing detection unit comprises a push switch including an operation button capable of being pressed and is provided on the substrate so that the operation button faces a lower side,
the pressing portion is disposed so as to face the pressing detection unit and is capable of pressing the operation unit, and
the pressing portion and the pressing detection unit are disposed close to the plunger.

5. The input device according to claim 1, further comprising:
rotation stopping members that are in the shape of a bar,
the operation unit includes rotation stopping guide portions that are on side surfaces in the shape of a notch, and
the rotation stopping members are engaged with the rotation stopping guide portions.

6. The input device according to claim 5,
wherein the rotation stopping guide portions are at positions where a straight line, which passes through a center of the operation unit and substantially bisects the operation unit, intersects with the side surfaces in plan view.
